(19) United States
(12) Patent Application Publication
(10) Pub. No.: US 2026/0138121 A1
(43) Pub. Date: May 21, 2026

(54) SUPPORTED NICKEL-COPPER CATALYST FOR DEHYDROGENATION AND HYDROGENATION OF LIQUID ORGANIC HYDROGEN CARRIERS

(71) Applicants: Chevron U.S.A. Inc., San Ramon, CA (US); The Regents of The University of California, Oakland, CA (US)

(72) Inventors: Enrique Iglesia, Moraga, CA (US); Karoline Kvande, Berkeley, CA (US); Trenton James Otto, San Francisco, CA (US); Steven Xuqi Song, Moraga, CA (US); Fang Wan, Beijing (CN); Bi-Zeng Zhan, Albany, CA (US); Zhongyao Zhang, GuangDong (CN)

(21) Appl. No.: 19/041,310

(22) Filed: Jan. 30, 2025

Related U.S. Application Data
(60) Provisional application No. 63/722,801, filed on Nov. 20, 2024.

(51) Int. Cl. B01J 23/755; B01J 21/04; B01J 35/30; C01B 3/00

(52) U.S. Cl. CPC B01J 23/755; B01J 21/04; B01J 35/30; C01B 3/0015

(57) ABSTRACT

A supported bimetallic catalyst includes (a) an inorganic oxide carrier, and (b) a copper-nickel metal component, wherein a content of the nickel metal component is from about 10 wt. % to about 50 wt. %, measured as elemental metal, and a molar ratio of copper to nickel is from about 0.1:1 to about 2:1. Processes for hydrogenation and dehydrogenation using the supported bimetallic catalyst are also disclosed.

### PRIORITY CLAIM

The present application claims priority to U.S. Provisional Patent Application Ser. No. 63/722,801, entitled “Dispersed Nickel and Nickel-Copper for Dehydrogenation of Liquid Organic Hydrogen Carriers,” filed Nov. 20, 2024, the content of which is incorporated by reference herein in its entirety.

### BACKGROUND

Hydrogen is an important fuel for future clean energy. Storage and transportation of hydrogen fuel from its production location to, for example, a hydrogen fueling station or other storage facility are often energy inefficient and/or costly. Efficient hydrogen production and transportation are well recognized as a technical barrier for hydrogen deployment at commercial scale. The storage of hydrogen in liquid organic hydrogen carrier (LOHC) systems has numerous advantages over conventional storage systems (e.g., compression and liquefaction technologies). Most importantly, hydrogen storage and transport in the form of a LOHC system enables the use of existing infrastructure that transports liquid fuels. Hydrogen storage in a LOHC system requires a highly exothermic hydrogenation step and an endothermic dehydrogenation step (i.e., one which requires an input of heat, at a temperature where the dehydrogenation of the carrier can proceed with adequate reaction rates).

### SUMMARY

In accordance with an illustrative embodiment, a supported bimetallic catalyst comprises:
(a) an inorganic oxide carrier, and
(b) a copper-nickel metal component, wherein a content of the nickel metal component is from about 10 wt. % to about 50 wt. %, measured as elemental metal; and a molar ratio of copper to nickel is from about 0.1:1 to about 2:1.

In accordance with another illustrative embodiment, a process comprises:
hydrogenating, in a hydrogenation reactor, a liquid organic hydrogen carrier with a hydrogen gas stream in the presence of a supported bimetallic catalyst under hydrogenation conditions to form a hydrogen-saturated liquid organic hydrogen carrier,
wherein the supported bimetallic catalyst comprises (i) an inorganic oxide carrier, and (ii) a copper-nickel metal component, wherein a content of the nickel metal component is from about 10 wt. % to about 50 wt. %, measured as elemental metal; and a molar ratio of copper to nickel is from about 0.1:1 to about 2:1.

In accordance with yet another illustrative embodiment, a process comprises:
dehydrogenating, in a dehydrogenation reactor, a feed comprising a hydrogen-saturated liquid organic hydrogen carrier under dehydrogenation conditions in the presence of a supported bimetallic catalyst to form hydrogen and a liquid organic hydrogen carrier,
wherein the supported bimetallic catalyst comprises (i) an inorganic oxide carrier, and (ii) a copper-nickel metal component, wherein a content of the nickel metal component is from about 10 wt. % to about 50 wt. %, measured as elemental metal; and a molar ratio of copper to nickel is from about 0.1:1 to about 2:1.

### BRIEF DESCRIPTION OF THE DRAWINGS

Exemplary embodiments of the present disclosure will be described below in more detail, with reference to the accompanying drawings, of which:

FIG. 1 is a plot illustrating (1) the gravimetric methylcyclohexane (MCH) conversion rates versus time on stream of a CuAl catalyst alone, a NiAl catalyst alone and Cuₓ—NiAl catalysts, and (2) the gravimetric rates versus (Cu/Ni) atom of the Cuₓ—NiAl catalysts of Example 2.

FIG. 2 is a plot illustrating (1) the gravimetric decalin (DCA) conversion rates versus time on stream of a NiAl catalyst, Cu/NiAl catalyst and a PdAl catalyst, and (2) the hydrogenolysis selectivity versus time on stream of a NiAl catalyst, Cu/NiAl catalyst and a PdAl catalyst of Example 3.

### DETAILED DESCRIPTION

Various illustrative embodiments described herein are directed to dispersed copper-nickel catalysts for dehydrogenation and hydrogenation of liquid organic hydrogen carriers, and systems and processes for producing hydrogen utilizing the dispersed copper-nickel catalysts.

Storage and transportation of hydrogen is a key enabling technology for the development of a hydrogen-based value-chain. LOHC are one of the various technologies in development for hydrogen transportation. LOHC systems are generally based on a pair of aromatic and alicyclic compounds or a pair of heteroaromatic and heterocyclic compounds, where reversible hydrogen storage and release are achieved by catalytic hydrogenation of a hydrogen-lean molecule (LOHC−) and catalytic dehydrogenation of the corresponding full hydrogenation product (LOHC+), respectively. Representative LOHC compound pairs include benzene and cyclohexane, toluene and methylcyclohexane and naphthalene and decalin.

As mentioned above, hydrogen storage in a LOHC system requires a highly exothermic hydrogenation step and an endothermic dehydrogenation step. For hydrogenation and dehydrogenation, supported noble metal catalysts, such as platinum (Pt), palladium (Pd), and ruthenium (Ru) are often used at relatively low metal loadings, e.g., around 1 wt. % or less. Due to the relatively low metal loadings of the supported noble metal catalysts, they will typically have low thermal conductivities. Thus, despite continued advancements in the selection and preparation of hydrogenation/dehydrogenation catalysts, these known dehydrogenation catalysts suffer from efficiency and stability issues as a result of having low thermal conductivities. These issues are typically exacerbated during the highly exothermic hydrogenation step and the prolonged dehydrogenation step of LOHC technologies.

Therefore, developing a suitable catalyst having high thermal conductivities for LOHC systems using a single catalyst for both dehydrogenation and hydrogenation that can overcome the issues associated with the highly exothermic hydrogenation step and the prolonged dehydrogenation step is highly desirable.

The non-limiting illustrative embodiments described herein overcome the drawbacks discussed above by providing a supported bimetallic catalyst having high thermal conductivities for use in a highly exothermic hydrogenation step and the prolonged dehydrogenation step without suffering from efficiency and stability issues. In addition, the supported bimetallic catalyst described herein containing copper and nickel advantageously provides an increased dehydrogenation rate in the dehydrogenation of liquid organic hydrogen carriers as compared to a supported copper catalyst or a supported nickel catalyst.

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

### Definitions

While systems and processes are described in terms of “comprising” various components or steps, the systems and processes can also “consist essentially of” or “consist of” the various components or steps, unless stated otherwise.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant' s intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means+20% of the stated value, +15% of the stated value, +10% of the stated value, +5% of the stated value, +3% of the stated value, or +1% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

The term “continuous” as used herein shall be understood to mean a system that operates without interruption or cessation for a period of time, such as where reactant(s) and catalyst(s) are continually fed into a reaction zone and products are continually or regularly withdrawn without stopping the reaction in the reaction zone.

The term “carrier” or “support” interchangeably refers to conventional materials that are typically a solid with a high surface area, to which catalyst materials are affixed. Support materials may be inert or participate in the catalytic reactions and may be porous or non-porous.

As used herein, the term “impregnated” or “impregnation” refers to permeation of the catalytic material into the porous structure of the support material.

The terms “benzyltoluene” and “dibenzyltoluene” include isomers of the compounds mentioned. In addition, the terms benzyltoluene and dibenzyltoluene also include substituted benzyl- or dibenzyltoluenes in which one or both benzyl groups are substituted by one or more groups selected from alkyl groups, such as methyl or ethyl groups, aryl groups, such as phenyl groups, and heteroaryl groups, such as pyridinyl groups.

The term “light cycle oil” and its acronym “LCO” as used herein refers to a middle distillate produced by fluid catalytic cracking units. The nominal boiling range for this stream is, for example, in the range of about 215° C. to 350° C. (e.g., 220° C. to 350° C., 215° C. to 343° C., or 220° C. to 343° C., 215° C. to 330° C., or 220° C. to 330° C.).

The terms “wt. %,” “vol. %,” or “mol. %” refer to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of the component.

### Supported Bimetallic Catalyst

In a non-limiting illustrative embodiment, a supported bimetallic catalyst includes (a) an inorganic oxide carrier, and (b) a bimetallic component comprising a copper-nickel metal component, wherein a content of the nickel metal component is from about 10 wt. % to about 50 wt. %, measured as elemental metal, and a molar ratio of copper to nickel is from about 0.1:1 to about 2:1.

In some embodiments, the content of the nickel metal component is from about 20 wt. % to about 40 wt. %, measured as elemental metal. In some embodiments, the content of the nickel metal component is from about 25 wt. % to about 35 wt. %, measured as elemental metal.

The inorganic oxide carrier may be in any of the commonly used catalyst shapes such as, for example, spheres, granules, pellets, chips, rings, extrudates, or powders that are well-known in the art.

The inorganic oxide carrier of the supported bimetallic catalyst is prepared by any of the suitable methods known to those skilled in the art for preparing shaped porous catalyst supports used to carry catalytically active metals. The inorganic oxide carrier or shaped inorganic oxide carrier comprises a porous refractory oxide or inorganic oxide component such as alumina (Al₂O₃), silica (SiO₂), titania (TiO₂), zirconia (ZrO₂), and physical mixtures or chemical combinations thereof. In some embodiments, an inorganic oxide for the shaped inorganic oxide carrier of the catalyst is one selected from the group consisting of alumina, silica, alumina-silica, and zirconia. Among these, the most preferred inorganic oxide is zirconia. In some embodiments, the inorganic oxide is present in the supported bimetallic catalyst in an amount within a range of from about 30 wt. % to about 95 wt. %, calculated as oxide on a calcined basis (e.g., about 40 wt. % to about 90 wt. %, or about 50 wt. % to about 80 wt. %).

The inorganic oxide carrier is formed into a shaped structure by any known suitable method. In some embodiments, spherically shaped structures such as particles of the inorganic oxide carrier can be made by the application of any of the known granulation methods. For example, in some embodiments, a granulation method can use an inclined rotating disk or pan that is fed particles of the inorganic oxide while spraying a cohesive slurry onto the particles. By this method, the particles are formed into spherically shaped particles. In some embodiments, spherically shaped carrier particles can have diameters in the range of from about 0.5 millimeter (mm) to about 25 mm.

In some embodiments, extruded shaped structures can be prepared by mixing an inorganic oxide powder with water and one or more additives to form a mixture having plastic properties and forming the mixture into extrudates by any of the known extrusion methods. The formed extrudates can be cylinders, lobed-shaped, quadrilobed-shaped, and twisted shapes having nominal extrudate diameters in the range of from about 0.5 mm to about 25 mm and extrudate lengths in the range of from about 1 mm to about 50 mm. The average aspect ratio is usually at most about 10, typically at most about 8, for instance at most about 5. The average length to diameter aspect ratio of the extrudates may range from about 1:1 to about 20:1 (e.g., about 2:1 to about 9:1, or about 4:1 to about 8:1).

In some embodiments, dry tableting methods may also be used to prepare the shaped carrier structure. In this method, cylindrical pellets or pills of the inorganic oxide are made by pressing a dry inorganic oxide powder that is optionally mixed with additives such as a lubricant and a binder, between two punches in a tableting press. In some embodiments, carrier particles that are cylindrical pellets can have pellet diameters in the range of from about 0.5 mm to about 25 mm and pellet lengths in the range of from about 1 mm to about 50 mm.

The shaped support particles are then dried under standard drying conditions that can include a drying temperature in the range of from about 50° C. to about 200° C. (e.g., about 75° C. to about 175° C., or about 90° C. to about 150° C.).

After drying, the shaped support particles are calcined under standard calcination conditions that include a calcination temperature in the range of from about 200° C. to about 800° C. (e.g., about 300° C. to about 700° C., or about 400° C. to about 600° C.).

The calcined shaped support is preferably porous and has a high surface area. The calcined shaped support can have Brunauer-Emmett-Teller (“BET”) surface area of at least about 20 m²/g (e.g., about 20 m²/g to about 500 m²/g, or about 100 m²/g to about 400 m²/g). The BET surface area may be determined by a method in accordance with ASTM D3663. The pore volume of the calcined shaped support can be in a range of from about 0.2 cm³/g to about 2.0 cm³/g (e.g., about 0.4 cm³/g to about 1.5 cm³/g, or about 0.4 cm³/g to about 1.2 cm³/g). Pore volumes disclosed herein may be measured by two methods, namely, the mercury method (ASTM 4284) and the nitrogen method (ASTM D4222).

The bimetallic component includes copper and nickel, i.e., a copper-nickel metal component. In some embodiments, the copper and nickel metal components may be present in a molar ratio of copper to nickel ranging from about 0.1:1 to about 2:1. In some embodiments, the copper and nickel metal components may be present in a molar ratio of copper to nickel ranging from about 0.1:1, or from about 0.2:1 and up to about 2:1, or up to about 1.9:1, or up to about 1.8:1, or up to about 1.7:1, or up to about 1.6:1, or up to about 1.5:1, or up to about 1.4:1, or up to about 1.3:1, or up to about 1.2:1, or up to about 1.1, or up to about 1:1, or up to about 0.9:1, or up to about 0.8:1, or up to about 0.75:1, where any of the lower limits can be combined with any of the upper limits.

In some embodiments, the content of the nickel metal component is from about 20 wt. % to about 40 wt. %, measured as elemental metal, and the molar ratio of copper to nickel is from about 0.2:1 to about 0.75:1.

In some embodiments, the content of the nickel metal component is from about 25 wt. % to about 35 wt. %, measured as elemental metal, and the molar ratio of copper to nickel is from about 0.2:1 to about 0.75:1.

In some embodiments, the inorganic oxide carrier is zirconium dioxide, the content of the nickel metal component is from about 20 wt. % to about 40 wt. %, measured as elemental metal, and the molar ratio of copper to nickel is from about 0.2:1 to about 0.75:1.

In some embodiments, the inorganic oxide carrier is zirconium dioxide, the content of the nickel metal component is from about 25 wt. % to about 35 wt. %, measured as elemental metal, and the molar ratio of copper to nickel is from about 0.2:1 to about 0.75:1.

In some embodiments, the inorganic oxide carrier is alumina, and the supported bimetallic catalyst has an effective thermal conductivity at least about 30% higher than the inorganic oxide carrier, or at least about 40% higher than the inorganic oxide carrier, or at least 50% higher than the inorganic oxide carrier.

In some embodiments, the supported bimetallic catalyst has an effective thermal conductivity of about 0.25 W/m/K to about 2 W/m/K, as determined by procedure ASTM E1461. In some embodiments, the supported bimetallic catalyst has an effective thermal conductivity of from about 0.30 W/m/K to about 1 W/m/K, as determined by procedure ASTM E1461. In some embodiments, the supported bimetallic catalyst has an effective thermal conductivity of about 0.30 W/m/K to about 0.45 W/m/K, as determined by procedure ASTM E1461.

### Method of Making the Supported Bimetallic Catalyst

In non-limiting illustrative embodiments, a supported bimetallic catalyst disclosed herein can be formed by introducing the copper and nickel metal components, either separately or simultaneously, onto the support in one or more steps. In some embodiments, the supported bimetallic catalyst disclosed herein can be prepared by sequentially or simultaneously treating the support, such as by impregnation, with one or more liquid compositions comprising the copper metal component or a precursor thereof, the nickel metal component or a precursor thereof or a precursor in a liquid carrier, such as water. An organic dispersant may be added to each liquid carrier to assist in uniform application of the metal component(s) to the support. Suitable organic dispersants include amino alcohols and amino acids, such as arginine. Generally, the organic dispersant is present in the liquid composition in an amount between 1 wt. % and 20 wt. % of the liquid composition.

In the preparation of aqueous solutions of the copper and nickel metal component precursors, salts of the copper and nickel metal components are used, such as their corresponding nitrate, amine complex (e.g., tetraammine), halide (e.g., chloride), carboxylate (e.g., acetate), or combinations thereof.

In some embodiments, the preparation of an impregnated shaped support body requires an aqueous mixture containing the copper metal component precursor, the nickel metal component precursor, and the shaped support body. In such embodiments, both precursors are in contact with the shaped support body at the same time.

In some embodiments, an aqueous solution containing the copper metal component precursor and the nickel metal component precursor is prepared in advance (such as by pre-mixing both components) prior to contact with the shaped support body for impregnation.

In some embodiments, the copper metal component and the nickel metal component are impregnated separately onto the same shaped support body. For example, in one embodiment, the nickel metal component is first impregnated onto the shaped support body to form a nickel metal component impregnated shaped support body. This support is further modified upon exposure to a solution of a copper metal component precursor to allow additional impregnation of the copper metal component onto the already impregnated shaped support body to generate the bimetallic impregnated inorganic oxide material described herein.

Following treatment of the support with the copper metal component or precursor solution and nickel metal component or precursor solution or solutions, the impregnated support is dried, such as by heat treating the support at elevated temperatures (e.g., about 50° C. to about 700° C.) for a period of time (e.g., about 1 to about 50 hours), and then calcined to convert the copper metal component and nickel metal component to more catalytically active forms. An exemplary calcination process involves one or more heat treatments of from about 350° C. to 550° C. for about 1 to about 5 hours in an oxidizing atmosphere, such as air, followed by heat treatment under reducing atmosphere conditions, such as hydrogen, e.g., to convert NiO and/or CuOₓ from their metal oxide to metal (zero-valent) forms. The above process can be repeated as needed to reach the desired level of the copper metal component and the nickel metal component impregnation.

A non-limiting schematic representation of a synthetic method for making a supported bimetallic catalyst is set forth in Scheme I below.

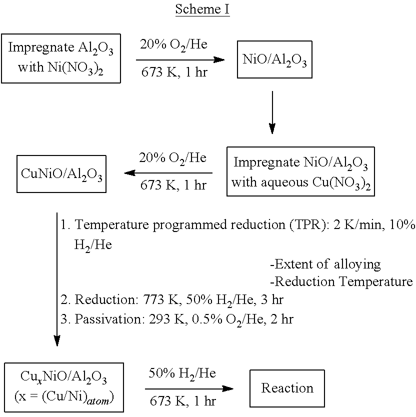

### Use of the Supported Bimetallic Catalyst

### 1. Hydrogenation Process

The supported bimetallic catalyst disclosed herein may be used generally for all chemical reactions for which supported bimetallic catalysts are suitable. In some embodiments, such reactions may include, for example, isomerization, oxidation, hydrogenolysis, hydrodesulfurization, hydrogenation/dehydrogenation, base oil hydrofinishing, hydrodewaxing, reforming, hydrodeoxygenation, and hydrodenitrogenation reactions.

In some embodiments, the supported bimetallic catalyst disclosed herein may be used in a selective hydrogenation process of one or more liquid organic hydrogen carriers. Suitable one or more liquid organic hydrogen carriers include, for example, aromatic hydrocarbon compounds or unsaturated hydrocarbon compounds which are converted into the respective saturated hydrocarbon compounds in a catalytic hydrogenation. Representative examples of aromatic hydrocarbon compounds include, but are not limited to, monoaromatic compounds, polyaromatic compounds, isomeric mixtures thereof and the like. Suitable liquid organic hydrogen carriers include, for example, toluene, benzyltoluene, dibenzyltoluene, alkylbenzenes, naphthalene, alkylnaphthalenes, fluorene, anthracene, diphenylethane, and N-alkylcarbazoles (e.g., N-methylcarbazole, N-ethylcarbazole, N-propylcarbazole), light cycle oils, and partially saturated derivatives thereof. In some embodiments, the aromatic hydrocarbon compound or the unsaturated hydrocarbon compound may be toluene, benzyltoluene or dibenzyltoluene. In some embodiments, alkylbenzenes include a compound in which 1 to 4 hydrogen atoms in the aromatic ring are substituted with a linear alkyl group or a branched alkyl group having 1 to 6 carbon atoms. Suitable alkylbenzenes for use herein include, for example, toluene, xylene, mesitylene, ethylbenzene, and diethylbenzene. Alkylnaphthalenes include a compound in which 1 to 4 hydrogen atoms in the aromatic ring are substituted with a linear alkyl group or a branched alkyl group having 1 to 6 carbon atoms. An example of such a compound includes methylnaphthalene. These compounds may be used alone or in combination.

In a non-limiting embodiment, when the aromatic hydrocarbon compound is toluene, the hydrogenation process can produce methylcyclohexane. In another non-limiting embodiment, when the aromatic hydrocarbon compound is naphthalene, the hydrogenation process can produce decalin (DCA), and there may be a relatively small amount of intermediate products. A generalized reaction pathway for the hydrogenation process of toluene and naphthalene is illustrated below in respective Scheme II and Scheme III. For the sake of simplicity, for the hydrogenation process illustrated for naphthalene to decalin, only the core structure of decalin is shown, however it is understood that the resulting decalin may have an isomer composition of, for example, 50% trans and 50% cis decalin isomers.

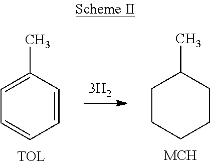

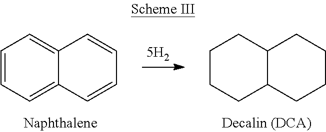 [SMILES: c1ccc2ccccc2c1 ; C1CCC2CCCCC2C1]

The supported bimetallic catalyst disclosed herein may be used in an amount of from about 0.01 parts by weight to about 10 parts by weight based on 100 parts by weight of the liquid organic hydrogen carrier.

The hydrogenation process may be accomplished by any means that generates a hydrogen-saturated liquid organic hydrogen carrier such as perhydrogenated or partially dehydrogenated cyclic hydrocarbons. In some embodiments, the liquid organic hydrogen carrier is contacted in a hydrogenation reactor with a hydrogen gas stream in the presence of the supported bimetallic catalyst disclosed herein under hydrogenation conditions capable of forming the hydrogen-saturated liquid organic hydrogen carrier. In some embodiments, the hydrogen gas stream can contain at least hydrogen. In some embodiments, the hydrogen gas stream can contain at least about 70 vol. % hydrogen, or at least about 90 vol. % hydrogen and up to about 99 vol. % hydrogen.

Suitable hydrogenation conditions for hydrogenating the liquid organic hydrogen carrier can comprise a temperature of from about 100° C. to about 375° C. (e.g., about 120° C. to about 300° C., or about 150° C. to about 250° C.). The pressure employed for the hydrogenation reaction is generally from about 0.1 MPa to about 10 MPa (e.g., about 0.5 MPa to about 8 MPa, or about 1 MPa to about 5 MPa). In some embodiments, the ratio of the hydrogen gas stream to the liquid organic hydrogen carrier can range from about 2000 scf/bbl to about 10,000 scf/bbl.

The hydrogenation process can be conducted with or without a solvent. When a solvent is used in the hydrogenation, aliphatic compounds including n-pentane, n-hexane, n-heptane, n-octane, n-nonane, n-decane, etc. and cycloalkane hydrocarbons including cyclohexane, cycloheptane, cyclooctane, cyclononane, cyclodecane, etc. may be used. In an embodiment, cyclohexane may be used as the solvent for the hydrogenation. When using a solvent, the solvent can be from about 20 wt. % to about 95 wt. % (e.g., about 30 wt. % to about 95 wt. %, or about 40 wt. % to about 95 wt. %, or about 50 wt. % to about 95 wt. %, or about 60 wt. % to about 95 wt. %, or about 70 wt. % to about 95 wt. %) of the feed mixture.

Generally, the hydrogenation process can be performed in any type of process which can hydrogenate a liquid organic hydrogen carrier to form the hydrogen-saturated liquid organic hydrogen carrier. In an embodiment, the hydrogenation process can be performed in a wide variety of batch, semi-batch, and continuous reactor systems. The configuration of the reactor is not critical. Suitable conventional hydrogenation reactors include, for example, stirred tank reactors, fixed bed reactors, trickle bed reactors, fluidized bed reactors, bubble flow reactors, plug flow reactors, buss loop reactors, and parallel flow reactors.

The hydrogenation process can be a partial or complete reaction, that is to say that hydrogenation reaction is complete when all of the double bonds capable of being hydrogenated present in, for example, an aromatic-containing liquid organic hydrogen carrier formulation are completely hydrogenated.

In some embodiments, when two or more hydrogenation reactors are employed, additional hydrogen can be added to the second and subsequent reactors if needed to compensate for the hydrogen consumption in the hydrogenation reaction carried out in the first hydrogenation reactor. Alternatively, in a single hydrogenation reactor, additional hydrogen can be added between catalyst beds through a set of inter-bed reactor internals, to make up the hydrogen consumption and provide quench to the process stream.

### 2. Dehydrogenation Reaction

Following completion of the hydrogenation process, the hydrogen-saturated liquid organic hydrogen carrier is sent to a dehydrogenation reactor to dehydrogenate the hydrogen-saturated liquid organic hydrogen carrier to form hydrogen and a partially or completely dehydrogenated liquid organic hydrogen carrier. For example, the hydrogen-saturated liquid organic hydrogen carrier can be dehydrogenated by methods well known in the art to generate a hydrogen-rich stream and a dehydrogenated liquid organic hydrogen carrier.

In non-limiting illustrative embodiments, the supported bimetallic catalyst of the present disclosure may be used for partial or complete dehydrogenation of the hydrogen-saturated liquid organic hydrogen carrier such as perhydrogenated or partially dehydrogenated cyclic hydrocarbons. For example, in some embodiments, the cyclic hydrocarbons are in either perhydrogenated or partly hydrogenated form, meaning that they have only a small number of carbon-carbon multiple bonds, if any. The perhydrogenated or partly hydrogenated cyclic hydrocarbons may, in addition to carbon and hydrogen, also contain heteroatoms, such as nitrogen. The perhydrogenated or partly hydrogenated cyclic hydrocarbons preferably do not contain any oxygen.

In some embodiments, the hydrogen-saturated liquid organic hydrogen carrier such as perhydrogenated or partly hydrogenated cyclic hydrocarbons include, for example, cyclohexane, methylcyclohexane, decalin, perhydrogenated or partly hydrogenated decalin and perhydrogenated or partly hydrogenated dibenzyltoluene and isomers thereof, perhydrogenated or partly hydrogenated light cycle oils. In addition, the hydrogen-saturated liquid organic hydrogen carrier can include, for example, perhydrogenated or partly hydrogenated N-alkylcarbazoles, such as perhydrogenated or partly hydrogenated N-methylcarbazole, N-ethylcarbazole and N-propylcarbazole.

In some embodiments, partly hydrogenated benzyltoluene includes benzyltoluene compounds in which at least one carbon-carbon double bond of the benzyltoluene has been replaced by a carbon-carbon single bond. Perhydrogenated benzyltoluene includes benzyltoluene compounds in which all of the carbon-carbon double bonds have been replaced by carbon-carbon single bonds. Representative examples of partly hydrogenated benzyltoluenes include 1-cyclohexylmethyl-2-methylbenzene, 1-cyclohexylmethyl-3-methylbenzene, 1-cyclohexylmethyl-4-methylbenzene, 1-benzyl-2-methylcyclohexane, 1-benzyl-3-methylcyclohexane, 1-benzyl-4-methylcyclohexane, 1-(1-cyclohexenylmethyl)-2-methylbenzene, 1-(1-cyclohexenylmethyl)-3-methylbenzene, 1-(1-cyclohexenylmethyl)-4-methylbenzene, 1-(1,3-cyclohexadienylmethyl)-2-methylbenzene, 1-(1,3-cyclohexadienylmethyl)-3-methylbenzene and 1-(1,3-cyclohexadienylmethyl)-4-methylbenzene.

Representative examples of perhydrogenated benzyltoluenes include 1-cyclohexylmethyl-2-methylcyclohexane, 1-cyclohexylmethyl-3-methylcyclohexane and 1-cyclohexylmethyl-4-methylcyclohexane.

A partly hydrogenated dibenzyltoluene includes, for example, any dibenzyltoluene compound in which at least one carbon-carbon double bond of the dibenzyltoluene has been replaced by a carbon-carbon single bond. A perhydrogenated dibenzyltoluene includes, for example, any dibenzyltoluene compound in which all of the carbon-carbon double bonds have been replaced by carbon-carbon single bonds. Representative examples of partly hydrogenated dibenzyltoluene include 1-benzyl-3-(cyclohexylmethyl)-5-methylbenzene, (5-methyl-1,3-phenylene)bis(methylene)dicyclohexane, 1-benzyl-4-(cyclohexylmethyl)-2-methylbenzene, (2-methyl-1,4-phenylene)bis(methylene)dicyclohexane, 2-benzyl-4-(cyclohexylmethyl)-1-methylbenzene, (4-methyl-1,3-phenylenc)bis(methylene) dicyclohexane, 1-benzyl-3-(cyclohexylmethyl)-2-methylbenzene, (2-methyl-1,3-phenylene)bis(methylene)dicyclohexane, 1-benzyl-2-(cyclohexylmethyl)-4-methylbenzene, (4-methyl-1,2-phenylene)bis(methylene)dicyclohexane, 1-benzyl-3-(1-cyclohexenylmethyl)-5-methylbenzene and 1-benzyl-3-(1,3-cyclohexadienylmethyl)-5-methylbenzene. Examples of perhydrogenated dibenzyltoluene are (5-methylcyclohexane-1,3-diyl)bis(methylene)dicyclohexane, (2-methylcyclohexane-1,4-diyl)bis(methylene)dicyclohexane, (4-methylcyclohexane-1,3-diyl)bis(methylene)dicyclohexane, (2-methylcyclohexane-1,3-diyl)bis(methylene)dicyclohexane and (4-methylcyclohexane-1,2-diyl)bis(methylene)dicyclohexane.

A partly hydrogenated N-alkylcarbazole, such as N-ethylcarbazole, includes any N-alkylcarbazole in which at least one carbon-carbon double bond present therein has been replaced by a carbon-carbon single bond. A perhydrogenated N-alkylcarbazole, such as N-ethylcarbazole, includes any N-alkylcarbazole in which all of the carbon-carbon double bonds present therein have been replaced by carbon-carbon single bonds. Representative examples of partly hydrogenated N-ethylcarbazole include 9-ethyl-2,3,4,9-tetrahydro-1H-carbazole, 9-ethyl-2,3,4,5,6,9-hexahydro-1H-carbazole, 9-ethyl-2,3,4,5,6,7,8,9-octahydro-1H-carbazole and 9-ethyl-2,3,4,4a,5,6,7,8,9,9a-decahydro-1H-carbazole. Perhydrogenated N-ethylcarbazole is, for example, 9-cthyldodecahydro-1H-carbazole.

In an illustrative embodiment, the hydrogen-saturated liquid organic hydrogen carrier can be contacted with the supported bimetallic catalyst described herein in a dehydrogenation reactor under dehydrogenation conditions. Suitable dehydrogenation reactors include, for example, a fixed catalyst bed system, a moving catalyst bed system, a fluidized bed system, or in a batch-type operation. The dehydrogenation reactor itself may comprise one or more separate reactor zones with heating means therebetween to ensure that the temperature can be maintained at the entrance to each reaction zone to obtain the desired conversion. The hydrogen-saturated liquid organic hydrogen carrier may be contacted with the supported bimetallic catalyst described herein in either upward, downward or radial flow fashion.

The dehydrogenation process may be partial or complete. The dehydrogenation process is complete when, for example, a fully saturated carbocyclyl or heterocyclyl radical (e.g., cyclohexyl or piperidinyl radicals) or a partially saturated carbocyclyl or heterocyclyl radical (e.g., cyclohexenyl or dihydropyridyl radicals) are converted to the corresponding aromatic form (e.g., phenyl or pyridyl radicals).

The hydrogen and the at least partially dehydrogenated liquid organic hydrogen carrier such as dibenzyl toluene may be separated in any convenient manner. The hydrogen may then be used, transported, and/or stored as desired.

In some embodiments, the dehydrogenation conditions include, for example, a temperature of from about 200° C. to about 500° C. (e.g., about 250° C. to about 450° C., or about 300° C. to about 400° C.), and a pressure of from about 20 kPa to about 500 kPa (e.g., about 50 kPa to about 400 kPa). The liquid hourly space velocity can range from about 0.1 h⁻¹ to about 4 h⁻¹ (e.g., about 1 h⁻¹ to about 2 h⁻¹). For better removal of hydrogen in the reaction, the reactor may be operated horizontally and may be open at the top; in this case, the catalyst is fixed by a mesh. The hydrogen can also be driven out by gases such as nitrogen, argon, but also hydrogen.

The following example is illustrative and intended to be non-limiting.

### Catalysts

The Cuₓ—Ni/Al₂O₃ catalysts of the present disclosure consisted of Ni metal (30 wt. %) and Al₂O₃ that has been additionally impregnated with Cu to achieve a Cu/Ni molar ratio of 0.1:1, 0.2:1, 0.3:1, 0.4:1, 0.6:1 and 0.75:1.

The Cu/Al₂O₃ catalyst consisted of Cu metal (30 wt. %) and Al₂O₃ support material.

The Ni/Al₂O₃ catalyst consisted of Ni metal (30 wt. %) and Al₂O₃ support material.

### Example 1

The Cu—Ni/Al₂O₃ catalysts were prepared by first impregnating an Al₂O₃ support with molten nickel nitrate at 338 K (148.7° F.) followed by ageing in stagnant ambient air at room temperature for 12 hours. The dried solids were heated to 673 K (751.7° F.) at 0.033 K s⁻¹ and calcined for 1 hour in flowing air (0.56 mL g⁻¹ s⁻¹) to obtain supported NiO precursors denoted (Ni/Al₂O₃). Samples containing Cu, i.e., CuₓNi/Al₂O₃(x=(Cu/Ni)ₐₜₒₘ), were prepared via one additional impregnation of NiO/Al₂O₃ with copper nitrate following steps analogous to those used for the preparation of Ni/Al₂O₃. The calcined samples were treated in 50% H₂/He flow (0.56 mL g⁻¹ s⁻¹) by increasing the temperature from ambient to 673 K (751.7° F.) at 0.033 K s⁻¹. The reduced samples were passivated in flowing 0.5% O₂/He mixture (0.56 mL g⁻¹ s⁻¹) for 2 hours at ambient temperature before exposure to ambient air to avoid pyrophoric phenomena.

### Example 2

### Dehydrogenation Testing with Methylcyclohexane

A bench-scale unit (BSU) dehydrogenation of methylcyclohexane (MCH) as a hydrogen-saturated liquid organic hydrogen carrier was performed using the conditions listed in Table 1.

TABLE 1
MCH Dehydrogenation Conditions

| Test Parameter | Parameter Value | |
|---|---|---|
| Total Pressure | 101 | kPa |
| LHSV | 0.400 | h⁻¹ |
| H₂ Supply Rate | 4.7 | mL/min |

| | |
|---|---|
| Pretreatment | Heating at 673 K (751.7° F.) in 50% H₂/He |
| | flow (2.8 mL g⁻¹ s⁻¹) for 1 h |
| Catalyst Charge | 1 mL total volume; 10-30 mg catalyst diluted |
| | with 2 g of quartz granules |
| Reaction C.A.T Targets | 573 K (571.7° F.) |

Catalysts were pelletized into 180 to 250 μm (60 to 80 mesh) aggregates and diluted with acid-washed quartz sand (Sigma Aldrich, 180-250 μm) to establish a homogeneous sampling. The quartz sand showed no activity for MCH dehydrogenation reactions under any of the conditions tested. The total volume of catalyst and quartz sand was kept at about 1 mL for each experiment, and the mixture was loaded in the center of a tubular fixed-bed quartz reactor with 8 mm inner diameter and 45.5 cm length. The reactor was then fixed within a three-zone resistively-heated furnace (Applied Test Systems, Series 3210). The reaction temperature was regulated using a Watlow controller and monitored by a K-type thermocouple (Omega) attached to the outer wall of the reactor near the center of the catalyst bed.

The catalysts were pretreated by heating to 673 K (751.7° F.) at 0.083 K s⁻¹ and holding for 1 hour in 50% H₂/He flow (2.8 mL g 1 s 1, Airgas, UHP grade) before cooling down to the prescribed reaction temperature. All the inlet flow rates of gases were manipulated by the electronic mass flow controllers (Parker). The liquid MCH (Sigma Aldrich, 99%) was introduced into the system using a syringe pump (Cole Parmer, Series 780100C) and vaporized immediately in the flowing H₂/He carrier. The relevant pipelines were kept at about 393 K (247.7° F.) to avoid the possible condensation of MCH and products during the transfer process. The effluent from the reactor was analyzed using an on-line gas chromatograph (Shimadzu, GC-2014) equipped with a dimethylpolysiloxane capillary column (Agilent, HP-1, 50 m×0.32 mm, 1.05 μm film thickness) and a flame ionization detector. All the products were identified by comparing the retention times with the corresponding authentic compounds.

Herein, the rate is reported as a gravimetric rate for MCH conversion per mass of the catalyst (mol g⁻¹ s⁻¹), r_{d} is the MCH conversion turnover rate (all dehydrogenation events) and rₕ is a sum of the side-reaction turnover rates that do not lead to toluene, but instead go through C—C cleavage.

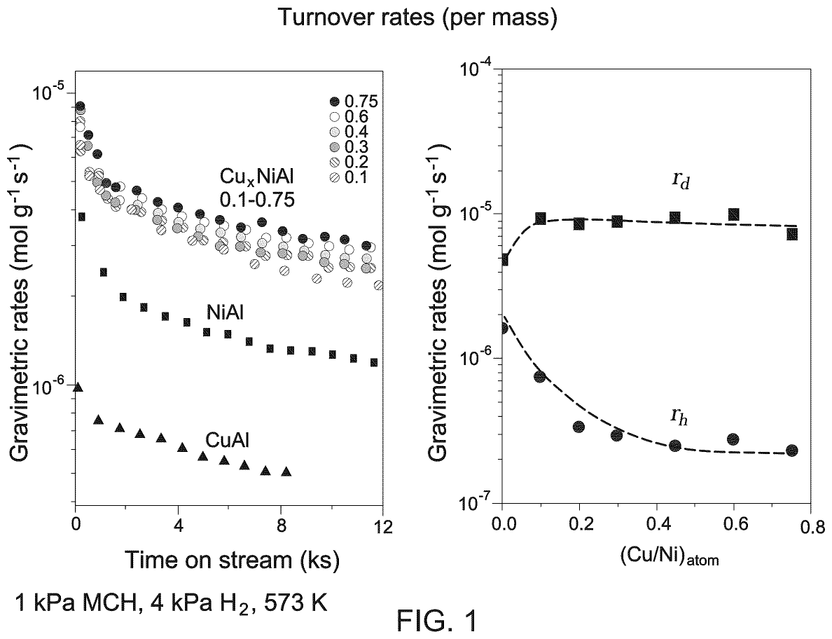

The dehydrogenation performance results at 573 K (571.7° F.) are illustrated in FIG. 1. A review of FIG. 1 shows that the Cuₓ—Ni/Al₂O₃ catalysts of the present disclosure exhibited a higher r_{d} as compared to the Cu/Al₂O₃ catalyst and the Ni/Al₂O₃ catalyst at 573 K (571.7° F.). This was unexpected as the Cu/Al₂O₃ catalyst showed a significantly lower gravimetric rate vs. time on stream as compared to the Ni/Al₂O₃ catalyst and the Cuₓ—Ni/Al₂O₃ catalysts. Thus, it can be seen that the addition of Cu to the Ni/Al₂O₃ catalyst provided a synergistic benefit to the r_{d} as shown in FIG. 1.

### Example 3

### Dehydrogenation Testing with Decalin

A bench-scale unit (BSU) dehydrogenation of decalin (DCA) as a hydrogen-saturated liquid organic hydrogen carrier was performed using the conditions listed in Table 2.

TABLE 2
DCA Dehydrogenation Conditions

| Test Parameter | Parameter Value | |
|---|---|---|
| Total Pressure | 101 | kPa |
| LHSV | 0.336 | h⁻¹ |
| H₂ Supply Rate | 10.7 | mL/min |

| | |
|---|---|
| Pretreatment | Heating at 673 K (751.7° F.) in 50% H₂/He |
| | flow (2.8 mL g⁻¹ s⁻¹) for 1 h |
| Catalyst Charge | 1 mL total volume; 20 mg catalyst diluted with |
| | 2 g of quartz granules |
| Reaction C.A.T Targets | 600 K (571.7° F.) |

Catalysts containing Ni and or Cu in this example were prepared analogously as described in Examples 1 and 2. The catalysts were examined for DCA dehydrogenation in addition to a noble metal (Palladium; Pd) catalyst prepared with an Al₂O₃ support, denoted Pd/Al₂O₃. This Pd/Al₂O₃ was prepared by incipient wetness impregnation of Al₂O₃ by aqueous Pd(NH₃)₄ (NO₃)₂ precursors.

Apparatus and procedures for reaction testing of the catalysts during DCA dehydrogenation were identical as described in Example 2. Herein, the rate is reported as a gravimetric rate for DCA conversion per mass of the catalyst (mol g⁻¹ s⁻¹), r_{d} is the DCA conversion turnover rate (all dehydrogenation events) and rₕ is a sum of the side-reaction turnover rates that do not lead to toluene, but instead go through C—C cleavage.

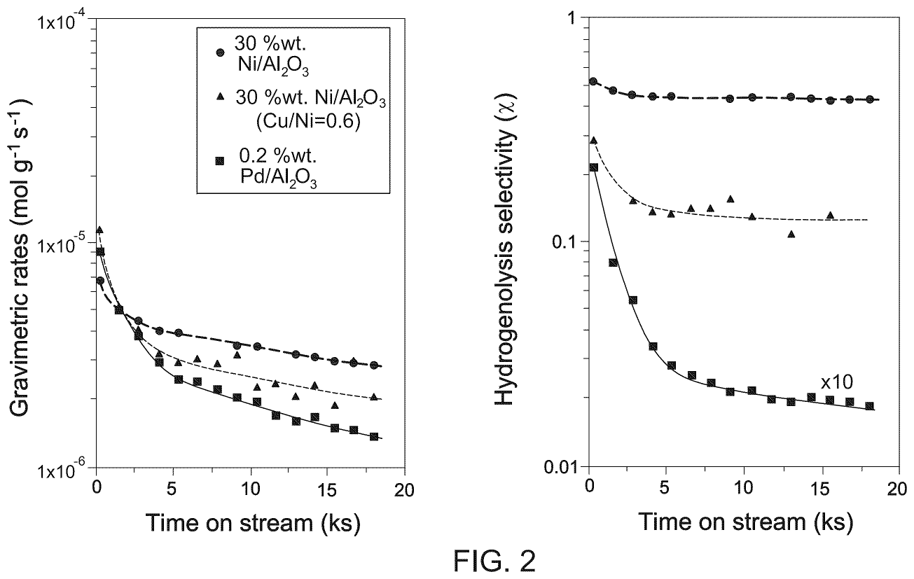

The dehydrogenation performance results at 573 K (571.7° F.) are illustrated in FIG. 2. A review of FIG. 2 shows that the Cu_{0.6}Ni/Al₂O₃ catalyst of the present disclosure exhibited a significantly lower hydrogenolysis selectivity than the Ni/Al₂O₃ catalyst at 573 K (571.7° F.), thus demonstrating the selectivity advantage of a bimetallic Cu—Ni dehydrogenation catalyst system with the DCA hydrogen carrier, which is in addition to the demonstrated advantage with the MCH carrier shown in Example 2.

According to an aspect of the present disclosure, a supported bimetallic catalyst comprises:
(a) an inorganic oxide carrier, and
(b) a copper-nickel metal component, wherein a content of the nickel metal component is from about 10 wt. % to about 50 wt. %, measured as elemental metal, and a molar ratio of copper to nickel is from about 0.1:1 to about 2:1.

In one or more additional illustrative embodiments, as may be combined with the preceding paragraphs, the inorganic oxide is selected from the group consisting of alumina, silicon dioxide, silica-alumina, titanium dioxide, zirconium dioxide, silicon carbide, and any combination thereof.

In one or more additional illustrative embodiments, as may be combined with the preceding paragraphs, the inorganic oxide carrier comprises particles and the inorganic oxide is zirconium dioxide.

In one or more additional illustrative embodiments, as may be combined with the preceding paragraphs, the molar ratio of copper to nickel is from about 0.1:1 to about 1.5:1.

In one or more additional illustrative embodiments, as may be combined with the preceding paragraphs, the molar ratio of copper to nickel is from about 0.1:1 to about 1.2:1.

In one or more additional illustrative embodiments, as may be combined with the preceding paragraphs, the molar ratio of copper to nickel is from about 0.1:1 to about 1:1.

In one or more additional illustrative embodiments, as may be combined with the preceding paragraphs, the molar ratio of copper to nickel is from about 0.1:1 to about 0.75:1.

In one or more additional illustrative embodiments, as may be combined with the preceding paragraphs, the content of the nickel metal component is from about 20 wt. % to about 40 wt. %, measured as elemental metal, and the molar ratio of copper to nickel is from about 0.2:1 to about 0.75:1.

In one or more additional illustrative embodiments, as may be combined with the preceding paragraphs, the content of the nickel metal component is from about 25 wt. % to about 35 wt. %, measured as elemental metal, and the molar ratio of copper to nickel is from about 0.2:1 to about 0.75:1.

In one or more additional illustrative embodiments, as may be combined with the preceding paragraphs, the inorganic oxide carrier is zirconium dioxide, the content of the nickel metal component is from about 20 wt. % to about 40 wt. %, measured as elemental metal, and the molar ratio of copper to nickel is from about 0.2:1 to about 0.75:1.

In one or more additional illustrative embodiments, as may be combined with the preceding paragraphs, the inorganic oxide carrier is zirconium dioxide, the content of the nickel metal component is from about 25 wt. % to about 35 wt. %, measured as elemental metal, and the molar ratio of copper to nickel is from about 0.2:1 to about 0.75:1.

In one or more additional illustrative embodiments, as may be combined with the preceding paragraphs, the inorganic oxide carrier is alumina, and the supported bimetallic catalyst has an effective thermal conductivity at least about 30% higher than the inorganic oxide carrier.

In one or more additional illustrative embodiments, as may be combined with the preceding paragraphs, the supported bimetallic catalyst has an effective thermal conductivity of about 0.25 W/m/K to about 2 W/m/K.

According to another aspect of the present disclosure, a process comprises:
hydrogenating, in a hydrogenation reactor, a liquid organic hydrogen carrier with a hydrogen gas stream in the presence of a supported bimetallic catalyst under hydrogenation conditions to form a hydrogen-saturated liquid organic hydrogen carrier,
wherein the supported bimetallic catalyst comprises (i) an inorganic oxide carrier, and (ii) a copper-nickel metal component, wherein a content of the nickel metal component is from about 10 wt. % to about 50 wt. %, measured as elemental metal, and a molar ratio of copper to nickel is from about 0.1:1 to about 2:1.

In one or more additional illustrative embodiments, as may be combined with the preceding paragraphs, the liquid organic hydrogen carrier comprises an aromatic hydrocarbon compound selected from the group consisting of benzene, toluene, benzyltoluene, dibenzyltoluene, xylene, naphthalene, fluorene, an N-alkylcarbazole, a light cycle oil, and any combination thereof.

In one or more additional illustrative embodiments, as may be combined with the preceding paragraphs, the content of the nickel metal component in the supported bimetallic catalyst is from about 20 wt. % to about 40 wt. %, measured as elemental metal, and the molar ratio of copper to nickel is from about 0.2:1 to about 0.75:1.

In one or more additional illustrative embodiments, as may be combined with the preceding paragraphs, the inorganic oxide is selected from the group consisting of alumina, silicon dioxide, silica-alumina, titanium dioxide, zirconium dioxide, silicon carbide, and any combination thereof.

In one or more additional illustrative embodiments, as may be combined with the preceding paragraphs, the inorganic oxide carrier comprises particles and the inorganic oxide is zirconium dioxide.

In one or more additional illustrative embodiments, as may be combined with the preceding paragraphs, the molar ratio of copper to nickel is from about 0.1:1 to about 1.5:1.

In one or more additional illustrative embodiments, as may be combined with the preceding paragraphs, the molar ratio of copper to nickel is from about 0.1:1 to about 1.2:1.

In one or more additional illustrative embodiments, as may be combined with the preceding paragraphs, the molar ratio of copper to nickel is from about 0.1:1 to about 1:1.

In one or more additional illustrative embodiments, as may be combined with the preceding paragraphs, the molar ratio of copper to nickel is from about 0.1:1 to about 0.75:1.

In one or more additional illustrative embodiments, as may be combined with the preceding paragraphs, the content of the nickel metal component is from about 20 wt. % to about 40 wt. %, measured as elemental metal, and the molar ratio of copper to nickel is from about 0.2:1 to about 0.75:1.

In one or more additional illustrative embodiments, as may be combined with the preceding paragraphs, the content of the nickel metal component is from about 25 wt. % to about 35 wt. %, measured as elemental metal, and the molar ratio of copper to nickel is from about 0.2:1 to about 0.75:1.

In one or more additional illustrative embodiments, as may be combined with the preceding paragraphs, the inorganic oxide carrier is zirconium dioxide, the content of the nickel metal component is from about 20 wt. % to about 40 wt. %, measured as elemental metal, and the molar ratio of copper to nickel is from about 0.2:1 to about 0.75:1.

In one or more additional illustrative embodiments, as may be combined with the preceding paragraphs, the inorganic oxide carrier is zirconium dioxide, the content of the nickel metal component is from about 25 wt. % to about 35 wt. %, measured as elemental metal, and the molar ratio of copper to nickel is from about 0.2:1 to about 0.75:1.

In one or more additional illustrative embodiments, as may be combined with the preceding paragraphs, the inorganic oxide carrier is alumina, and the supported bimetallic catalyst has an effective thermal conductivity at least about 30% higher than the inorganic oxide carrier.

In one or more additional illustrative embodiments, as may be combined with the preceding paragraphs, the supported bimetallic catalyst has an effective thermal conductivity of about 0.25 W/m/K to about 2 W/m/K.

According to yet another aspect of the present disclosure, a process comprises:
dehydrogenating, in a dehydrogenation reactor, a feed comprising a hydrogen-saturated liquid organic hydrogen carrier under dehydrogenation conditions in the presence of a supported bimetallic catalyst to form hydrogen and a liquid organic hydrogen carrier,
wherein the supported bimetallic catalyst comprises (i) an inorganic oxide carrier; and (ii) a copper-nickel metal component, wherein a content of the nickel metal component is from about 10 wt. % to about 50 wt. %, measured as elemental metal, and a molar ratio of copper to nickel is from about 0.1:1 to about 2:1.

In one or more additional illustrative embodiments, as may be combined with the preceding paragraphs, the hydrogen-saturated liquid organic hydrogen carrier comprises a perhydrogenated or partly hydrogenated cyclic hydrocarbon.

In one or more additional illustrative embodiments, as may be combined with the preceding paragraphs, the perhydrogenated or partly hydrogenated cyclic hydrocarbon is selected from the group consisting of cyclohexane, methylcyclohexane, decalin, a perhydrogenated or partly hydrogenated benzyltoluene, a perhydrogenated or partly hydrogenated dibenzyltoluene, a perhydrogenated or partly hydrogenated N-alkylcarbazole, a perhydrogenated or partly hydrogenated light cycle oil and any combination thereof.

In one or more additional illustrative embodiments, as may be combined with the preceding paragraphs, the content of the nickel metal component in the supported bimetallic catalyst is from about 20 wt. % to about 40 wt. %, measured as elemental metal, and the molar ratio of copper to nickel is from about 0.2:1 to about 0.75:1.

In one or more additional illustrative embodiments, as may be combined with the preceding paragraphs, the inorganic oxide is selected from the group consisting of alumina, silicon dioxide, silica-alumina, titanium dioxide, zirconium dioxide, silicon carbide, and any combination thereof.

In one or more additional illustrative embodiments, as may be combined with the preceding paragraphs, the inorganic oxide carrier comprises particles and the inorganic oxide is zirconium dioxide.

In one or more additional illustrative embodiments, as may be combined with the preceding paragraphs, the molar ratio of copper to nickel is from about 0.1:1 to about 1.5:1.

In one or more additional illustrative embodiments, as may be combined with the preceding paragraphs, the molar ratio of copper to nickel is from about 0.1:1 to about 1.2:1.

In one or more additional illustrative embodiments, as may be combined with the preceding paragraphs, the molar ratio of copper to nickel is from about 0.1:1 to about 1:1.

In one or more additional illustrative embodiments, as may be combined with the preceding paragraphs, the molar ratio of copper to nickel is from about 0.1:1 to about 0.75:1.

In one or more additional illustrative embodiments, as may be combined with the preceding paragraphs, the content of the nickel metal component is from about 20 wt. % to about 40 wt. %, measured as elemental metal, and the molar ratio of copper to nickel is from about 0.2:1 to about 0.75:1.

In one or more additional illustrative embodiments, as may be combined with the preceding paragraphs, the content of the nickel metal component is from about 25 wt. % to about 35 wt. %, measured as elemental metal, and the molar ratio of copper to nickel is from about 0.2:1 to about 0.75:1.

In one or more additional illustrative embodiments, as may be combined with the preceding paragraphs, the inorganic oxide carrier is zirconium dioxide, the content of the nickel metal component is from about 20 wt. % to about 40 wt. %, measured as elemental metal, and the molar ratio of copper to nickel is from about 0.2:1 to about 0.75:1.

In one or more additional illustrative embodiments, as may be combined with the preceding paragraphs, the inorganic oxide carrier is zirconium dioxide, the content of the nickel metal component is from about 25 wt. % to about 35 wt. %, measured as elemental metal, and the molar ratio of copper to nickel is from about 0.2:1 to about 0.75:1.

In one or more additional illustrative embodiments, as may be combined with the preceding paragraphs, the inorganic oxide carrier is alumina, and the supported bimetallic catalyst has an effective thermal conductivity at least about 30% higher than the inorganic oxide carrier.

In one or more additional illustrative embodiments, as may be combined with the preceding paragraphs, the supported bimetallic catalyst has an effective thermal conductivity of about 0.25 W/m/K to about 2 W/m/K.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present disclosure and are disclosed herein just as if each and every such sub-combination was individually and explicitly disclosed herein.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

1. A supported bimetallic catalyst, comprising:
(a) an inorganic oxide carrier; and
(b) a copper-nickel metal component, wherein a content of the nickel metal component is from about 10 wt. % to about 50 wt. %, measured as elemental metal; and a molar ratio of copper to nickel is from about 0.1:1 to about 2:1.

2. The supported bimetallic catalyst according to claim 1, wherein the inorganic oxide is selected from the group consisting of alumina, silicon dioxide, silica-alumina, titanium dioxide, zirconium dioxide, silicon carbide, and any combination thereof.

3. The supported bimetallic catalyst according to claim 1, wherein the inorganic oxide carrier comprises particles and the inorganic oxide is zirconium dioxide.

4. The supported bimetallic catalyst according to claim 1, wherein the molar ratio of copper to nickel is from about 0.1:1 to about 1.5:1.

5. The supported bimetallic catalyst according to claim 1, wherein the molar ratio of copper to nickel is from about 0.1:1 to about 1.2:1.

6. The supported bimetallic catalyst according to claim 1, wherein the molar ratio of copper to nickel is from about 0.1:1 to about 1:1.

7. The supported bimetallic catalyst according to claim 1, wherein the molar ratio of copper to nickel is from about 0.1:1 to about 0.75:1.

8. The supported bimetallic catalyst according to claim 1, wherein the content of the nickel metal component is from about 20 wt. % to about 40 wt. %, measured as elemental metal, and the molar ratio of copper to nickel is from about 0.2:1 to about 0.75:1.

9. The supported bimetallic catalyst according to claim 1, wherein the content of the nickel metal component is from about 25 wt. % to about 35 wt. %, measured as elemental metal, and the molar ratio of copper to nickel is from about 0.2:1 to about 0.75:1.

10. The supported bimetallic catalyst according to claim 1, wherein the inorganic oxide carrier is zirconium dioxide, the content of the nickel metal component is from about 20 wt. % to about 40 wt. %, measured as elemental metal, and the molar ratio of copper to nickel is from about 0.2:1 to about 0.75:1.

11. The supported bimetallic catalyst according to claim 1, wherein the inorganic oxide carrier is zirconium dioxide, the content of the nickel metal component is from about 25 wt. % to about 35 wt. %, measured as elemental metal, and the molar ratio of copper to nickel is from about 0.2:1 to about 0.75:1.

12. The supported bimetallic catalyst according to claim 1, wherein the inorganic oxide carrier is alumina, and the supported bimetallic catalyst has an effective thermal conductivity at least about 30% higher than the inorganic oxide carrier.

13. The supported bimetallic catalyst according to claim 1, having an effective thermal conductivity of about 0.25 W/m/K to about 2 W/m/K.

14. A process, comprising:
hydrogenating, in a hydrogenation reactor, a liquid organic hydrogen carrier with a hydrogen gas stream in the presence of a supported bimetallic catalyst under hydrogenation conditions to form a hydrogen-saturated liquid organic hydrogen carrier;
wherein the supported bimetallic catalyst comprises (i) an inorganic oxide carrier; and (ii) a copper-nickel metal component; wherein a content of the nickel metal component is from about 10 wt. % to about 50 wt. %, measured as elemental metal; and a molar ratio of copper to nickel is from about 0.1:1 to about 2:1.

15. The process according to claim 14, wherein the liquid organic hydrogen carrier comprises an aromatic hydrocarbon compound selected from the group consisting of benzene, toluene, benzyltoluene, dibenzyltoluene, xylene, naphthalene, fluorene, an N-alkylcarbazole, a light cycle oil, and any combination thereof.

16. The process according to claim 14, wherein the content of the nickel metal component in the supported bimetallic catalyst is from about 20 wt. % to about 40 wt. %, measured as elemental metal, and the molar ratio of copper to nickel is from about 0.2:1 to about 0.75:1.

17. A process, comprising:
dehydrogenating, in a dehydrogenation reactor, a feed comprising a hydrogen-saturated liquid organic hydrogen carrier under dehydrogenation conditions in the presence of a supported bimetallic catalyst to form hydrogen and a liquid organic hydrogen carrier;
wherein the supported bimetallic catalyst comprises (i) an inorganic oxide carrier; and (ii) a copper-nickel metal component; wherein a content of the nickel metal component is from about 10 wt. % to about 50 wt. %, measured as elemental metal; and a molar ratio of copper to nickel is from about 0.1:1 to about 2:1.

18. The process according to claim 17, wherein the hydrogen-saturated liquid organic hydrogen carrier comprises a perhydrogenated or partly hydrogenated cyclic hydrocarbon.

19. The process according to claim 18, wherein the perhydrogenated or partly hydrogenated cyclic hydrocarbon is selected from the group consisting of cyclohexane, methylcyclohexane, decalin, a perhydrogenated or partly hydrogenated benzyltoluene, a perhydrogenated or partly hydrogenated dibenzyltoluene, a perhydrogenated or partly hydrogenated N-alkylcarbazole, a perhydrogenated or partly hydrogenated light cycle oil and any combination thereof.

20. The process according to claim 17, wherein the content of the nickel metal component in the supported bimetallic catalyst is from about 20 wt. % to about 40 wt. %, measured as elemental metal, and the molar ratio of copper to nickel is from about 0.2:1 to about 0.75:1.
